(19) United States
(12) Patent Application Publication
(10) Pub. No.: US 2017/0212916 A1
(43) Pub. Date: Jul. 27, 2017

(54) DUPLICATE POST HANDLING WITH NATURAL LANGUAGE PROCESSING

(71) Applicant: International Business Machines Corporation, Armonk, NY (US)

(72) Inventors: Jason T. Albert, Rochester, MN (US); Christopher J. Engel, Rochester, MN (US); Kahn C. Evans, ROCHESTER, MN (US); Steven B. Janssen, ROCHESTER, MN (US); Matt K. Light, ROCHESTER, MN (US); David R. Nickel, ROCHESTER, MN (US); Karl M. Solie, ROCHESTER, MN (US); Michael L. Trantow, ROCHESTER, MN (US)

(21) Appl. No.: 15/075,383

(22) Filed: Mar. 21, 2016

Related U.S. Application Data
(63) Continuation of application No. 15/004,098, filed on Jan. 22, 2016.

(51) Int. Cl. G06F 17/30; G07C 13/00

(52) U.S. Cl. CPC G06F 17/30303; G06F 17/30867; G07C 13/00

(57) ABSTRACT

A method prevents duplicate posts within a question and answer forum. The method may compare the user question vector to each of the plurality of corpus question vectors to determine the closest match between the user question vector and the corpus question vectors to obtain an identified question and answer row, and determine if the identified Q and A row has a last answer that has a corresponding confidence to the question of the identified Q and A row that exceeds a confidence threshold. Responsive to a positive determination, the method may determine if the user question is similar to a question in the identified Q and A row, and if so the server may determine that the last answer is similar to any answer in the identified Q and A row that is not the last answer, and in response, block the submission of the user question.

The present invention is a continuation of the U.S. patent application Ser. No. 15/004,098, filed Jan. 22, 2016, titled “Prevent Duplicate Posts Within a Forum or Community Using Natural”, incorporated herein by reference. The present invention relates to a computer implemented method, data processing system, and computer program product for consolidating social network postings and more specifically to gathering questions that are phrased differently, but concerning the same subject, to a common thread.

### BACKGROUND

Modern uses of networked computers allow users to crowd-source wisdom by bringing like-minded users to ask questions or otherwise pose problems, and then receive answers from the community. However, users dislike searching for answers prior to asking their question or can have trouble using the more industry standard terminology, and thus will search, in vain, with terms that are mere synonyms to the terms of a previously asked question.

This situation leads to at least two problems. First, redundant questions are posted, and then need to be redacted or cross-linked to a previously asked version of the question by moderators. In addition, the moderator still has to actually find the original question, if he is able.

Second, a user, who posts the new question, has no awareness of the existing set of answers, and so, may needlessly wait, and hover expectantly in an unproductive manner.

Accordingly, some remedy would be beneficial.

### SUMMARY

According to one embodiment of the present invention a method may prevent duplicate posts within a question and answer (Q and A) forum. The method may receive a user question from a user at the Q and A forum. The method may apply natural language processing to the user question to form a user question vector. The method may apply natural language processing to each question in a question and answer (Q and A) corpus to form a plurality of corpus question vectors, wherein each question is in a row having at least the question. The method may compare the user question vector to each of the plurality of corpus question vectors to determine a closest match between the user question vector and the corpus question vectors to obtain an identified question and answer (Q and A) row. The method may determine if the identified Q and A row has a last answer that has a corresponding confidence to the question of the identified Q and A row that exceeds a confidence threshold. Responsive to a positive determination, the method may determine if the user question is similar to a question in the identified Q and A row above a question similarity threshold. In case of a positive determination, the method may determine that the last answer is measured as more similar, by comparison to any answer in the identified Q and A row that is not the last answer, than a preset similarity threshold, and in response, block the submission of the user question as a distinct question and directing the user to at least one answer of the identified Q and A row. However, if the method did not determine that the user question is similar to a question in the identified Q and A row, the method may post the user question as an unanswered question.

### BRIEF DESCRIPTION OF THE DRAWINGS

FIG. 1 is a block diagram of a data processing system in accordance with an illustrative embodiment of the invention;

FIG. 2 is a block diagram of a question and answer server (Q and A server) in a network configuration with a client in accordance with an embodiment of the invention;

FIG. 3 is an exemplary Q and A corpus in accordance with an embodiment of the invention;

FIG. 4 is a table representation of a data structure for a question and answer corpus (Q and A corpus) in accordance with an embodiment of the invention; and

FIG. 5 is a flowchart in accordance with an embodiment of the invention.

### DETAILED DESCRIPTION

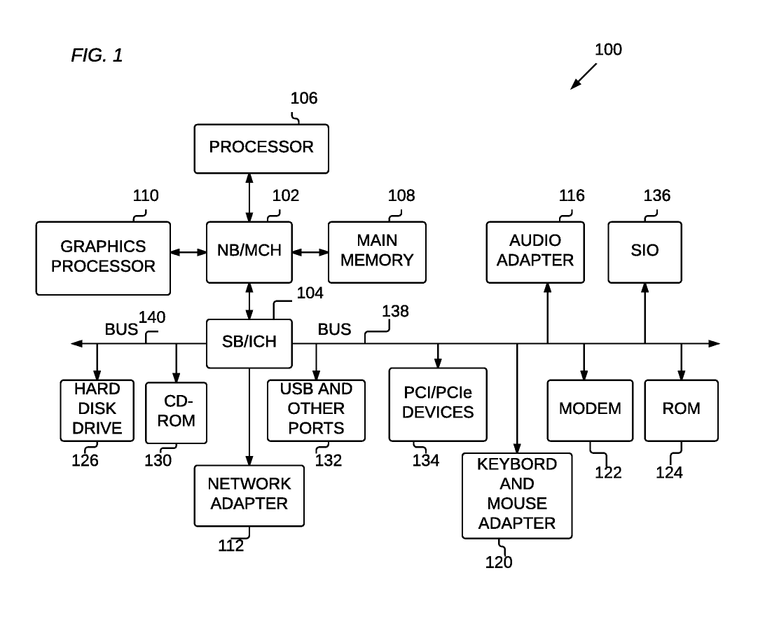

With reference now to the figures and in particular with reference to FIG. 1, a block diagram of a data processing system is shown in which aspects of an illustrative embodiment may be implemented. Data processing system 100 is an example of a computer, in which code or instructions implementing the processes of the present invention may be located. In the depicted example, data processing system 100 employs a hub architecture including a north bridge and memory controller hub (NB/MCH) 102 and a south bridge and input/output (I/O) controller hub (SB/ICH) 104. Processor 106, main memory 108, and graphics processor 110 connect to north bridge and memory controller hub 102. Graphics processor 110 may connect to the NB/MCH through an accelerated graphics port (AGP), for example.

In the depicted example, local area network (LAN) adapter 112 connects to south bridge and I/O controller hub 104 and audio adapter 116, keyboard and mouse adapter 120, modem 122, read only memory (ROM) 124, hard disk drive (HDD) 126, CD-ROM drive 130, universal serial bus (USB) ports and other communications ports 132, and PCI/PCIe devices 134 connect to south bridge and I/O controller hub 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to south bridge and I/O controller hub 104.

An operating system runs on processor 106, and coordinates and provides control of various components within data processing system 100 in FIG. 1. The operating system may be a commercially available operating system such as Microsoft® Windows® XP. Microsoft and Windows are trademarks of Microsoft Corporation in the United States, other countries, or both. An object oriented programming system, such as the Java™ programming system, may run in conjunction with the operating system and provides calls to the operating system from Java™ programs or applications executing on data processing system 100. Java™ is a trademark of Sun Microsystems, Inc. in the United States, other countries, or both.

Instructions for the operating system, the object-oriented programming system, and applications or programs are located on computer readable tangible storage devices, such as hard disk drive 126, and may be loaded into main memory 108 for execution by processor 106. The processes of the embodiments can be performed by processor 106 using computer implemented instructions, which may be located in a memory such as, for example, main memory 108, read only memory 124, or in one or more peripheral devices.

Those of ordinary skill in the art will appreciate that the hardware in FIG. 1 may vary depending on the implementation. Other internal hardware or peripheral devices, such as flash memory, equivalent non-volatile memory, and the like, may be used in addition to or in place of the hardware depicted in FIG. 1. In addition, the processes of the illustrative embodiments may be applied to a multiprocessor data processing system.

In some illustrative examples, data processing system 100 may be a personal digital assistant (PDA), which is configured with flash memory to provide non-volatile memory for storing operating system files and/or user-generated data. A bus system may be comprised of one or more buses, such as a system bus, an I/O bus, and a PCI bus. Of course, the bus system may be implemented using any type of communications fabric or architecture that provides for a transfer of data between different components or devices attached to the fabric or architecture. A communication unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted example in FIG. 1 is not meant to imply architectural limitations. For example, data processing system 100 also may be a tablet computer, laptop computer, or telephone device in addition to taking the form of a PDA.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, one or more embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

The illustrative embodiments permit a question to be reviewed automatically by a question and answer (Q and A) server for redundancy to questions already present in the Q and A server so that a single thread of answers can be maintained for a question and similar versions of the question. As such, answers may be concentrated and compared within a common thread, rather than forcing users to execute plural searches amongst disparate questions. Moreover, embodiments may permit judgments to be made concerning whether a newly submitted question is distinct from other questions, without relying on moderators to read each question. Further, embodiments, may, where the newly submitted question is similar to an existing question, and at least two answers of that existing question are themselves similar, block the addition of the newly submitted question as a variant to the existing question.

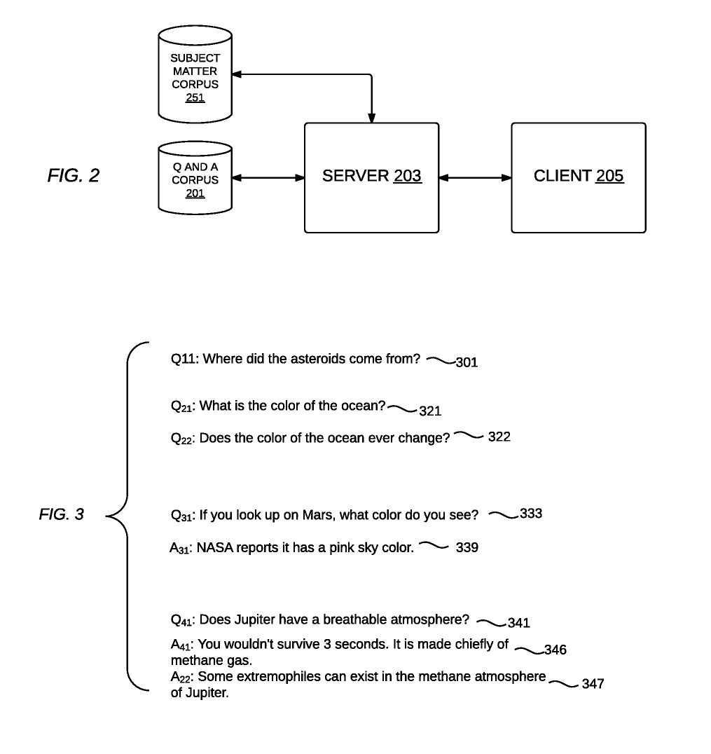

FIG. 2 is a block diagram of a question and answer server (Q and A server) in a network configuration with a client in accordance with an embodiment of the invention. Q and A server 203 may be arranged using the data processing system 100 of FIG. 1. Q and A server 203 may host executing programs and data stores that permit it to respond to inputs from users across a network, for example, from a user using client 205. Client 205 may be a data processing system according to FIG. 1. Q and A server 203 may render content of, for example a Q and A corpus 201 to provide the functionality of a Q and A forum. A Q and A forum is the hosting of a website that permits browsing through questions, posting answers to those questions and the retrieval of answers to those questions. Users may be screened provided they agree to conform to a terms of service of the Q and A forum. The Q and A forum can be a subset of functionality that is presented from within a social network that has additional features. A user is any person who operates the client, either directly, or through indirect methods such as, for example, scheduled posting of content.

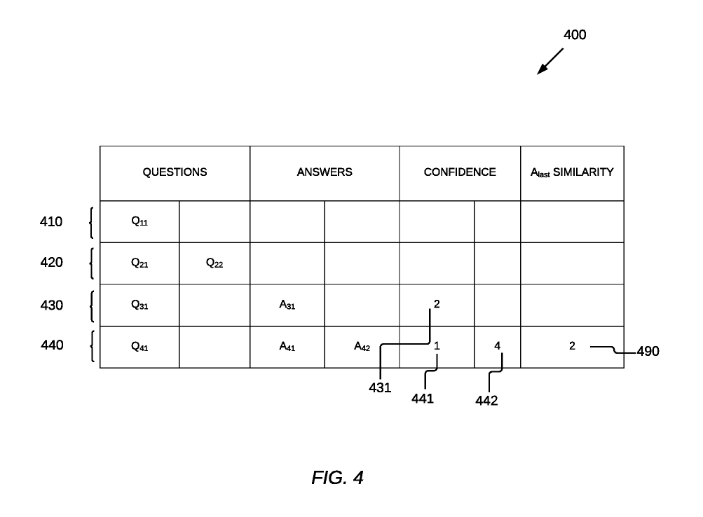

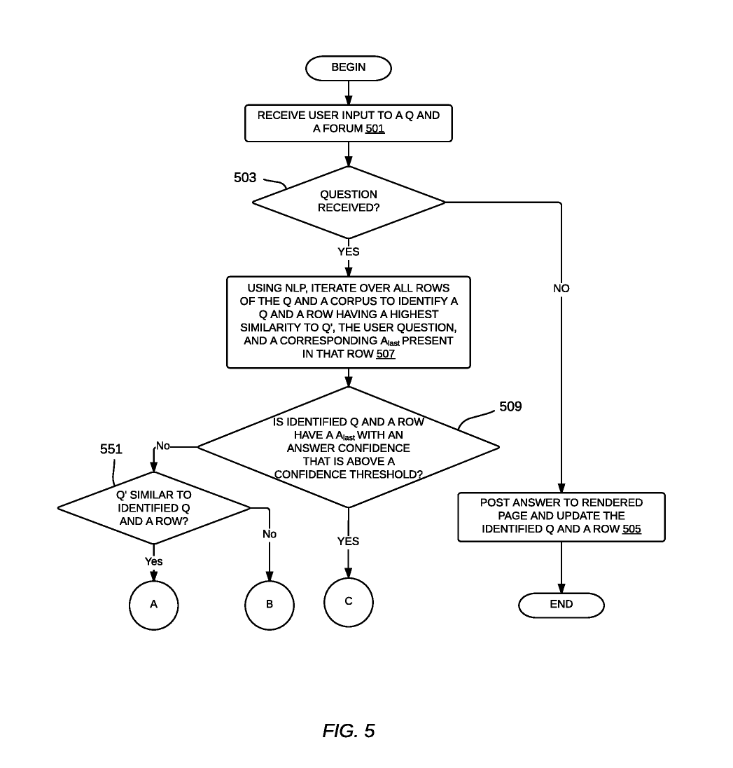

Content of the questions may be searched in exchanges using, for example, the hypertext transfer protocol (http), whereby screen details and configuration is transmitted from the server 203 to the client 205 for rendering at the client. The server 203 performs at least three basic functions. First, it permits a user to ask a question, and under some circumstances, incorporate that question to a Q and A corpus 201 from which the server 203 stores questions and answers. A Q and A corpus 201 is a data store of questions and corresponding answers. The Q and A corpus may be data arranged to a storage device, which can be part of server 203 or a remote data store accessed via a network. The Q and A corpus 201 will be described in more full detail at FIGS. 3 and 4.

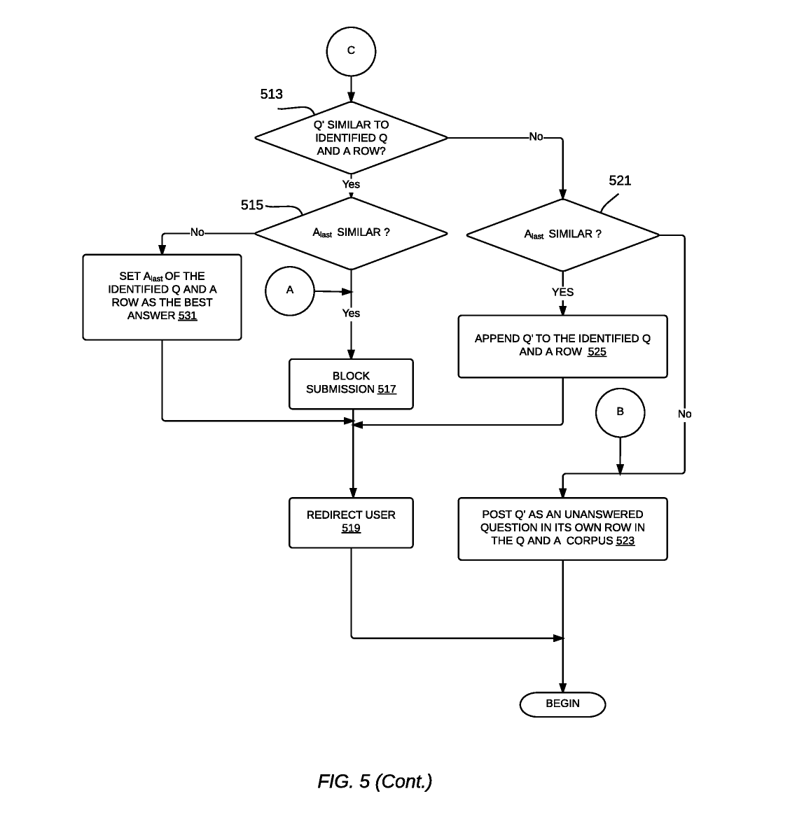

As a supplement to the Q and A corpus, server 203 may refer to subject matter corpus 251 to provide reference data on how stable a particular domain is in terms of consensus agreement on answers and/or controversy concerning evidence for the domain. Any corpus of knowledge that is regularly updated, and has corresponding taxonomy that breaks knowledge into categories of subject matter can be used as the subject matter corpus. As an example, the Wikipedia™ free encyclopedia can be used since it records both information, and identifies the dates on which each edit occurs. Wikipedia™ is a registered trademark of the Wikimedia Foundation, Inc. As such, the Wikipedia™ free encyclopedia, and other corpuses like it, can be used as a proxy for the degree of controversy that a particular domain may have, particularly, since Wikipedia organizes its page entries into discrete subject matters or domains. The subject of domain stability is explained further with respect to FIG. 5, below.

FIG. 3 is a listing of the content of an exemplary Q and A corpus 201 in accordance with an embodiment of the invention. Question 301 is a question that has been asked, but as yet, has no corresponding answer. Question 321 is another question that has been asked, but lacks a corresponding answer. Question 322 is a question judged to be so similar to question 321 that the question is treated as an alternate version of question 321. Question 321 and question 322 may be stored as associated with each other. Question 333 has a corresponding answer 339. Question 341, in this example, is a question that has earned the most popularity, as it has two answers: answer 346 and answer 347.

Answers may be added to the Q and A corpus by user submissions. For example, as an answer, one or more users may add their free form text to a data field when browsing each question. When an answer is given, for a question with other answers, the new answer can be lexically broken down and compared to other answers for a given question. If a data processing system can categorize that answer in a set with other similar answers, then, providing a count of answers in that set is higher than any set of alternative answers, that newly given answer may be determined to be a highly confident answer. In contrast, an answer that cannot be categorized within a set of similar answers, may be graded with a lower confidence. Confidence values in an answer may be supplemented by factors of stability associated with an answer. Answer stability is explained further below, with reference to FIG. 5.

Among the questions, question 301, question 333 and question 341 are each distinct questions, while the other questions are not. A distinct question, is a question that has no other questions associated with it as being a variant or a duplicate of the question. Embodiments of the invention may store a question to the Q and A corpus 201 provided that the question is determined to be sufficiently dissimilar to the existing questions.

In determining a similarity of one question to another, a metric can be determined for each hypothetical pairing of questions. For example, a user question is posed or otherwise submitted. A user question is a question that is transmitted by a user for incorporation to the Q and A forum. Each question may be processed by a natural language processing algorithm that executes in a data processing system, such as server 203. The natural language processing algorithm may take many forms. For example, the natural language processing (NLP) algorithm may identify the root or primary lexical unit of a word for each of the questions. The NLP algorithm may be implemented on, for example, server 203 of FIG. 2. NLP can then assign a score to the pair of questions based on a count of how many roots are in both the first question and the second question of the pair. Under this form of NLP, the question 321 and question 322 have a score of four. Using this form of NLP, the question 301 and question 321 have a score of one, since only the word ‘the’ is common between the two questions. A feature can be a word root located in a sentence, and may include numbers, symbols and the like. As such, additional features, beyond word roots, can be compared when quantifying similarity between questions or answers.

NLP may come in many different variations and with further conditions on the score. Some versions of NLP may discard simple parts of speech, since their contribution to the overall meaning of the sentence(s) is minimal. Other versions of NLP may place a greater emphasis on brevity, or weight words that are mentioned earlier in a sentence more heavily than those at an end of a sentence, or those at an end to a paragraph of sentences. Accordingly, the NLP algorithm can vary widely in its complexity and results. Further, in counting the number of roots that a question has in common with a second question, the NLP may count as identical, two roots that are synonymous, for example, the numeric form of “10” as compared to the alphabetically spelled out “ten”.

The NLP algorithm may further reduce the complexity of a question, an answer or other lexical structures. A user question vector may be a reduction in the question to a list of root words, possibly subtracting any overly common words, also known as “stop words”. The roots may themselves be replaced by a canonical or preferred synonym, if an unusual or archaic form of the root is actually present in the user question.

When user question vectors are compared, a number is the result. That number, or score, can be compared to a pre-determined question similarity threshold, which is used in FIG. 5, explained below. A question similarity threshold may be the number of words or roots in each of a pair of questions, that each question has in common, and may be looked up by counting strings in user question vectors that are available from NLP. A question similarity threshold of 3.5 can be used for the Q and A corpus of FIG. 3. A similar NLP algorithm may be used to judge a similarity between answers, particularly answers that correspond to a row having one or more questions stored therein (See FIG. 4, block 440, below).

The server may perform analysis between answers to a question in a similar manner as the analysis of similarity between questions. Thus, answers that are judged to be similar may be counted to form a score for the set of questions found to be similar. An answer frequency is a score assigned to an answer based on a count of other answers, for the same question, that the answer is similar with respect thereto. For example, an answer that is twice given, is determined as more confident than an answer that is only given once. Accordingly, the answer frequency can change as further answers are added to the question.

A question may have different correct answers at different times. For example, a question, “What is the current version of Microsoft Windows®?” may at one time, have a correct answer of “Version 7”, but as new commercial releases of the Microsoft product are made available, that answer may no longer be correct, and be replaced with a more correct answer of “Version 10”. A last answer is the most recently given answer stored to a Q and A row and may also be known as the latest answer.

Each answer may have a corresponding confidence score as it relates to the first question with which it is associated. The confidence score may be established by a number of different means, such as, for example, counting a number of citations mentioned in the answer. A citation can be any embedded html link, or a presence of a string of text that matches a syntax for a bibliographical reference. Alternatively, a confidence score can be a summation of votes both positive and negative. The Q and A forum may solicit votes for each answer by collecting clicks on any buttons that suggest “like”; “up vote” or the like. In contrast, any clicks to “dislike”; “down vote” and the like would indicate a negative confidence vote by the user(s). In other words, a vote is an indication of approval or disapproval by a user. Thus, an example of the confidence score can be a sum of the positive votes, minus the sum of the negative votes. A combination of the number of citations and votes can also be used to generate a confidence score. Confidence scores may be stored and updated as per FIG. 4, below.

A confidence threshold can be a pre-set level set by a system administrator of the Q and A server. For example, in using a confidence tallying method of up-votes minus down-votes, a confidence threshold may be 1.

Confidence may be collected and/or calculated for similarity between answers, for example, as established by the NLP processing, described above. A determination of similarity between two answers may be modified by a confidence factor established by this alternative/supplement to NLP processing. As such, any judgment, in the flowchart of FIG. 5, below, may further apply the confidence factor as a modifier of a raw score of similarity generated by NLP.

FIG. 4 is a table representation of a data structure for a question and answer corpus (Q and A corpus) in accordance with an embodiment of the invention. The Q and A corpus can be comprised of multiple rows, although initially, the Q and A corpus may be empty. A row comprises at least one question. Sufficiently similar questions may be added later, as explained further below. Similarly, answers may be posted by users to answer or supplemental answer a question. Accordingly, 0 or more answers can be associated to a question on a row. Question 301 is represented as Q₁₁ in row 410 of Q and A corpus 400. Similarly, the pairing of questions 321, 322 are symbolically associated in row 420 as Q₂₁ and Q₂₂. Additional rows 430 and 440 include, respectively the associations of Q₃₁, A₃₁ and, Q₄₁, A₄₁, A₄₂. The final row 440 has plural answers including the last answer added, A₄₂. A last answer, is the final answer provided among a group of answers. The answer is final, in that it is the most recently added answer.

Each answer of FIG. 4 may periodically have scores related to it updated. For example, A₃₁ may have an answer confidence of 2 431. Answer A₄₁ may have an answer confidence of 1 441. Answer A₄₂ may have an answer confidence of 4 442.

Furthermore, Answer A₄₂, being the last answer, may be compared to earlier answers for similarity scores. Answer A₄₂, as compared to Answer A₄₁ may be rated 2 in similarity 490. If row 440 had a third answer, the last answer would have two values of similarity, one for each of its predecessor answers. Each row may optionally have a confidence value assigned for each answer, and last answer similarity value assigned to every pairing of the last answer to previous answers, if any. The Aₗₐₛₜ similarity values are used, for example, at steps 515 and 521, below, in FIG. 5. For questions that have a single answer or lack any answers, a null value in the Aₗₐₛₜ similarity column is treated as 0 or that the Aₗₐₛₜ is not similar to other answers associated to the question(s) in that row of the Q and A corpus.

FIG. 5 is a flowchart in accordance with an embodiment of the invention. Initially a server, for example, Q and A server 203 of FIG. 2, may receive a user input from a user at the Q and A forum 501. The server may determine if a question is received 503. If no question is received, the server may post the user input as an answer to a corresponding question by updating a row in the Q and A corpus that contains the corresponding question 505. In addition, the server may treat the answer as a last answer, and establish an initial answer confidence at zero, and store a list of similarities between the last question, and each previous question in the row, if any. The server, without any further answers to the question, can label the answer as the best answer, with respect to the question.

However, if step 503 is positive, and a question is received, the server may apply natural language processing to the user question to form a user question vector 507. Step 507 may include applying natural language processing to each question in a Q and A corpus to form a plurality of corpus question vectors. As such, the user question vector can be compared to each of the plurality of corpus question vectors to determine a closest match between the user question vector and the corpus question vectors to obtain an identified Q and A row. In addition, the last answer is located within that row.

Next, the server can determine if the last answer exceeds a confidence threshold 509. The confidence in a last answer may be determined by a combination of several factors. A first factor, is the number of times that an answer, or one similar to it, is posted to the question, particularly in relation to other answers. This factor, as explained above, is also known as answer frequency.

A second factor for determining the confidence of an answer can be based on the stability of a body of knowledge that an answer is derived from, for example, by the server. This second factor is known as “domain stability”. For example, data processing system equipped with natural language processing (NLP), such as, for example, the Watson supercomputer, can use knowledge that is stored and updated like an encyclopedia or online sources such as Wikipedia™ free encyclopedia, which can be a subject matter corpus 251 of FIG. 2. Such corpuses, receive user-submitted revisions from time to time. For example, a subject domain of “buggy whips” may have relatively few updates during a period of time. The buggy whip industry as a major economic entity ceased to exist with the introduction of the automobile. In contrast, the subject domain of “integrated circuits” may have relatively many updates during the same period of time. Accordingly, answers that are automatically produced, or even answers posted by users associated with the “buggy whip” domain, may be modified to be of higher confidence than simply relying on answer-frequency alone, at least with respect to domains of continuing development such as “integrated circuits”.

A third factor for determining the confidence of an answer is time period analysis. Time period analysis relies more heavily on answers posted or automatically generated in the near time, while discounting answers posted or automatically generated during distant time periods. As such, applying time period analysis can override an answer that has many, but older submissions with a contrary answer that has fewer submissions, but those submissions occur during a more recent time period than the former older answers. Accordingly, time period analysis responds to answer trends, as can occur, when a question such as, “What is the age of Mariah Carey” are answered through-out the years. Use of such an analysis enables the server to discard older, obsolete answers when sufficient corrective answers are given.

More information on domain stability and time period analysis may be obtained from “Watson and Healthcare,” by Michael Yuan, et al., IBM developerWorks, 2011 and “The Era of Cognitive Systems: An Inside Look at IBM Watson and How it Works” by Rob High, IBM Redbooks, 2012, and U.S. patent application Ser. No. 14/588,910, entitled, “Determining Answer Stability in a Question Answering System”, which are herein incorporated by reference.

A corresponding confidence level for the last answer may be determined by retrieving the stored confidence value, for example, confidence 442 applicable to A₄₂ at row 440 of FIG. 4. In response to a positive result, the server may determine if the user question is similar to a question in the identified Q and A row 513. This step may iterate over all questions in identified Q and A row, and select the one that has a highest score for similarity. As such, the server determines a closest match between the user question vector and the corpus question vectors by using this Q and A row that has the highest score for similarity. With respect to this existing question, the server determines if the similarity to the user question exceeds the confidence threshold. The confidence threshold may be preset by a system administrator of the server.

Next, in response to a positive result at step 513, the server may determine if the last answer in the identified Q and A row is similar above a last threshold to any answer in the identified Q and A row that is not the last answer 515. If the last answer surpasses the last threshold, then the server may block the submission of the user question as a distinct question 517. The last threshold is a preset comparison value for comparing similarity of a last answer to any previous answer. In other words, the server may use previously measured similarities between the last answer and other answers in the Q and A row, comparing each, or at least comparing the highest such measured similarity, to the last threshold. The system administrator of the server may set this last threshold value. Blocking can mean that the server inhibits, for example, immediate posting of the question to the Q and A corpus. Blocking can also mean that the server also does not reserve the user question for review by moderators. In other words, blocking can mean entirely discarding the user question. The server may then redirect the user to at least one answer of the identified Q and A row 519. Redirecting can include the server, in response to the user submission, rendering to the user the content of the identified Q and A row to a window displayed by the client. Rendering content can mean that some details of the questions and answers might extend beyond the immediately visible window, but be available after a user scrolls, or unfolds a collapsed portion of the displayed content. Processing may terminate thereafter.

However, in response to a negative result at step 513, the server may determine if the last answer is similar to any one of any previously submitted answers to the identified Q and A row 521. If no other answers are present in identified Q and A row, or if the most similar answer to the last answer falls below a last threshold, step 521 is determined negatively. In such a case, the server may post the user question as an unanswered question 523. Posting the question can include adding the user question as a new Q and A row, without any corresponding answer. Processing may terminate thereafter.

However if the result to step 521 is positive, the server may append the user question to the identified Q and A row 525. Next, the server may redirect the user to the content of the identified Q and A row 519. Processing may terminate thereafter.

As a result to a negative result to step 515, the server may identify the last answer as the best answer within the identified Q and A row 531. Next, the server may redirect the user to the user to the content of the identified Q and A row 519. Processing may terminate thereafter.

In response to a negative result at step 509, the server may determine if the user question is similar to a question in the identified Q and A row 551. If the user question is similar, then the server may block the submission of the user question 517, followed by redirecting the user to the identified Q and A row 519. However, if the user question is not similar the server may post the user question as an unanswered question 523. An unanswered question is a question that has no corresponding answer stored with it in the Q and A corpus row that the unanswered question is stored to. Row 411 of FIG. 4 is an example of an unanswered question. Processing may terminate thereafter.

The illustrative embodiments permit a user to submit a question for a Q and A server to consider for addition to a Q and A corpus. The question can be at least reviewed against the entirety of the Q and A corpus to find a previously submitted question that is similar, and in some cases, where it is similar, the question is merged an/or appended to a previous Q and A row of the corpus or the question is entirely blocked from addition to the Q and A corpus. Thus, the server can relieve a moderator or other users from flagging questions as duplicates as well as reducing a dilution of answers being submitted redundantly to two separate questions. In other words, by folding plural versions of the same question together, the server can increase the concentration of good answers to a single point or rendered page. Moreover, the blocking of adding, as a distinct question, a question that rightfully is judged redundant, reduces redundancy in search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or computer readable tangible storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for preventing duplicate posts within a question and answer (Q and A) forum, the method comprising:
receiving a user question from a user at the Q and A forum;
applying natural language processing to the user question to form a user question vector;
applying natural language processing to each question in a question and answer (Q and A) corpus to form a plurality of corpus question vectors, wherein each question is in a row having at least the each question;
comparing the user question vector to each of the plurality of corpus question vectors to determine a closest match between the user question vector and the corpus question vectors to obtain an identified question and answer (Q and A) row;
determining if the identified Q and A row has a last answer that has a corresponding confidence to the question of the identified Q and A row that exceeds a confidence threshold and in response,
determining if the user question has a higher similarity to a question in the identified Q and A row as compared to a question similarity threshold,
and if so, determining that at least one pairing of the last answer to another answer in the identified Q and A row has a similarity exceeding a last threshold, and in response, blocking the submission of the user question as a distinct question and directing the user to at least one answer of the identified Q and A row;
and if not, posting the user question as an unanswered question.

2. The computer implemented method of claim 1, wherein determining if the user question has a higher similarity to a question in the identified Q and A row as compared to a question similarity threshold comprises:
iterating over all questions in the identified Q and A row and comparing a user question vector to each of the question vectors to each of all questions to determine a question in the identified Q and A row having the highest similarity to the user question; and
determining if the question in the identified Q and A row having the highest similarity to the user question exceeds the question similarity threshold.

3. The computer implemented method of claim 1, wherein determining if the identified Q and A row has the last answer that has the corresponding confidence to the question comprises summing at least one vote corresponding to the last answer.

4. The computer implemented method of claim 3, wherein the confidence threshold is at least one vote.

5. The computer implemented method of claim 1, wherein posting the user question as an unanswered question comprises storing the user question to the Q and A corpus as a new row to the Q and A corpus.

6. The computer implemented method of claim 1, wherein applying natural language processing to the user question comprises reducing each word to a word root to form the user question vector.

7. The computer implemented method of claim 1, wherein posting the user question as an unanswered question further comprises:
determining that the last answer is not similar below a last threshold to any answer in the identified Q and A row that is not the last answer, and in response, posting the user question as an unanswered question.
